(19) United States
(12) Patent Application Publication
(10) Pub. No.: US 2013/0313879 A1
(43) Pub. Date: Nov. 28, 2013

(54) INTEGRATED CONTINUOUS RECLINER AND MOTOR ASSEMBLY

(71) Applicant: Ronald Bedro, Plymouth, MI (US)

(72) Inventor: Ronald Bedro, Plymouth, MI (US)

(73) Assignee: Johnson Controls Technology Company, Holland, MI (US)

(21) Appl. No.: 13/993,505

(22) PCT Filed: Dec. 29, 2011
(86) PCT No.: PCT/US2011/067956

§ 371 Date: Aug. 12, 2013

Related U.S. Application Data
(60) Provisional application No. 61/427,842, filed on Dec. 29, 2010.

(51) Int. Cl. B60N 2/22

(52) U.S. Cl. CPC B60N 2/2213
USPC 297/362

(57) ABSTRACT

An integrated continuous recliner and motor assembly for a seat includes a recliner mechanism with inner base plate, disc member, first wedge member and second wedge member disposed about a shaft, a biasing member that operatively engages the wedge members with a cam member, a retainer ring member having outwardly extending tabs, a first recliner gear having gear teeth for rotatably engaging the seat and a second recliner gear engaged with the first recliner gear teeth. A gear motor has an output shaft and a transmission including a gear train, drive shaft and a drive tab that engage the first wedge and second wedge. The motor rotational torque transferred from the output shaft to drive shaft rotate the wedges until either one contacts the cam member to initiate rotational movement of the first recliner gears to adjust the angular position of the seat back with respect to the seat base.

### CROSS REFERENCE TO RELATED APPLICATIONS

This application claims the benefit of and priority to U.S. Provisional Application No. 61/427,842, filed Dec. 29, 2010, which is incorporated, herein by reference.

### BACKGROUND

The present disclosure relates generally to the field of vehicle seats. More specifically, this disclosure relates to an integrated continuous recliner and motor assembly for a vehicle seat.

Conventional vehicle seats typically include a seat back pivotably coupled to a seat base by an adjustment mechanism, such as, a recliner mechanism. The recliner mechanism enables the seat occupant to selectively adjust the angular orientation of the seat back relative to the seat base according to the occupant's needs. Further, the recliner mechanism may provide for discrete angular adjustment positions or may provide for continuous angular adjustment position. Vehicle seats may also include other adjustment mechanisms for adjusting additional seat attributes, such as, the fore-and-aft or horizontal position of the seat relative to the vehicle steering wheel, the vertical elevation of the seat relative to the vehicle floor, the lumbar support area of the seat back, or the like. Many adjustment mechanisms are powered by a motor or transmission mechanism that provides torque to move the seat or a seat component in a particular direction, such as, forward, backward, up, down, or the like. The recliner mechanism may also be powered by a motor having a transmission or gear train. The gear train includes a system of gears that transfer rotational torque generated by the motor to another component of the mechanism to thereby adjust the vehicle seat.

While conventionally available recliner mechanisms powered by a motor are functional, such systems are relatively complex and bulky. Further, the necessity to incorporate such recliner mechanisms in a compact package often render them relatively complex with numerous components and therefore costly to manufacture. Moreover, the motors utilized with conventional recliner mechanisms can also be inefficient and waste energy. Thus there is a need for an integrated continuous recliner and motor assembly that has a more compact construction, operates more efficiently and is more cost-effective to produce and assembly.

### SUMMARY

An integrated recliner and motor assembly for use with a vehicle seat includes a continuous recliner mechanism and a motor. The recliner mechanism includes a biasing member, a first and second wedge member, a cam member, a first ring member, an inner base plate, a second ring member, a first gear plate, a second gear plate, and a driver ring member. The motor assembly includes a motor having a transmission housing coupled thereto, and a drive shaft extending from the motor and coupled to a gear train. The gear train is disposed within the transmission housing and includes a first and second gear. The second gear includes a shaft and a drive tab that engage the first and second wedge. The motor generates rotational torque and transfers the rotational torque from the drive shaft to the shaft and drive tab of the second. gear to rotate the wedges and to thereby drive the recliner mechanism and enable adjustment of the vehicle seat.

An advantage of the present disclosure is that integrated continuous recliner and motor assembly is provided that is compact due to a simpler construction with fewer parts. Another advantage of the present disclosure is that the integrated continuous recliner and motor assembly operates more efficiently. Another advantage of the present disclosure is that the integrated continuous recliner and motor assembly is more energy efficient to operate. Yet another advantage of the present disclosure is less torque is required to operate the recliner, so that a smaller motor can be used that is more compact and energy efficient. A further advantage of the present disclosure is that the integrated continuous recliner and motor assembly is easier to assemble, resulting in reduced time to assembly and improved manufacturing cost. Yet a further advantage of the present disclosure is that the recliner and motor are packaged in the same compact housing. Still a further advantage of the present disclosure is that the motor is a gear motor and the gear transmission directly drives the recliner wedges to move the recliner and seat back. Still yet a further advantage of the present disclosure is that the wedges can be integrated with the gear motor's transmission gears.

Other features and advantages of the present disclosure will be readily appreciated, as the same becomes better understood after reading the subsequent description taken in conjunction with the accompanying drawings.

### BRIEF DESCRIPTION OF THE DRAWINGS

FIG. 1 is a perspective view of a vehicle having a vehicle seat with an integrated continuous recliner and motor assembly, according to an exemplary embodiment.

FIG. 2 is a perspective view of the vehicle seat of FIG. 1.

FIG. 3 is a perspective view of a seat frame assembly for the vehicle seat of FIG. 2.

FIG. 4a is an exploded perspective view of an integrated continuous recliner and motor assembly, for the vehicle seat of FIG. 2.

FIG. 4b is an exploded perspective view of the continuous recliner mechanism for the integrated continuous recliner and motor assembly of FIG. 4a.

FIG. 4c is an exploded perspective view of a motor for the integrated continuous recliner and motor assembly of FIG. 4a.

FIG. 5a is a partial exploded perspective view of an example of a modified motor, for use in the integrated continuous recliner and motor assembly of FIG. 4a.

FIG. 5b is a side view of the drive tab of FIG. 5a.

FIG. 6a is a side view of another example of the integrated continuous recliner and motor assembly.

FIG. 6b is a partial exploded perspective view of the motor assembly of FIG. 6a.

FIG. 6c is a side view of the drive tab of FIG. 6a.

### DETAILED DESCRIPTION

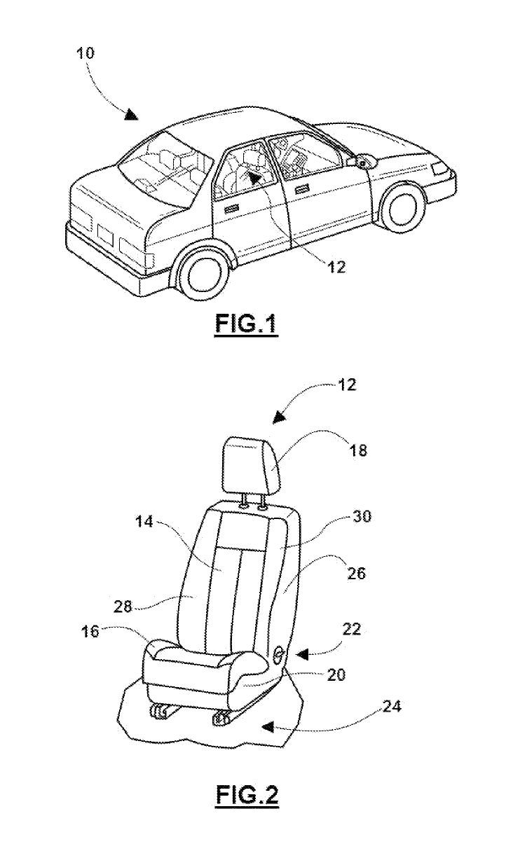

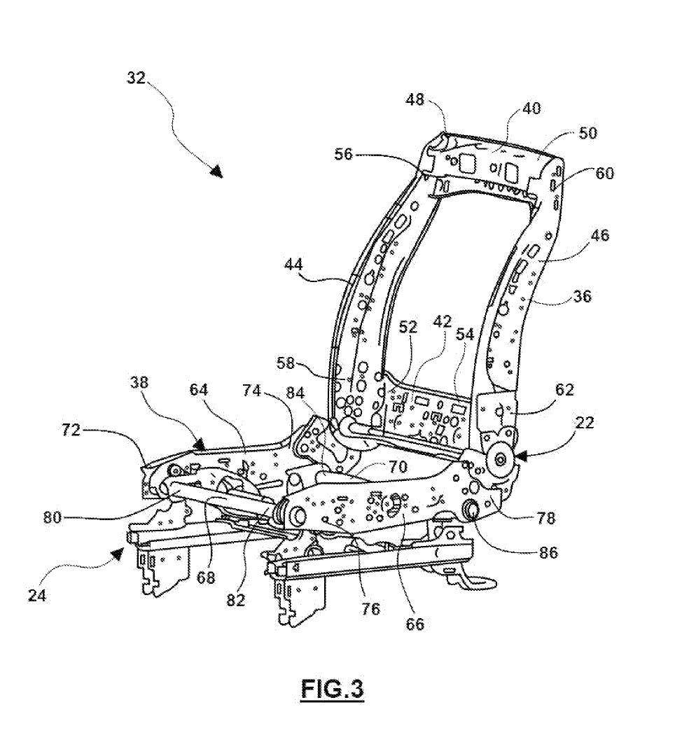

Referring to FIGS. 1-3, a seat assembly 12 for use in a vehicle is illustrated. While the vehicle 10 shown is an automobile, it should be understood that the seat 12 may be used in any type of vehicle used to accommodate a seated occupant, including a passenger vehicle, train, airplane, boat or any other means in or by which someone travels or something is carried or conveyed. The seat 12 illustrated is a one-occupant seat typically used in the from row of a vehicle, but the seat structures of the present disclosure may be incorporated into any vehicle seat, such as a second row scat, a second row bench, a third row fold flat, or the like, which may utilize any type of seat functionality. Further, the seat assembly 12 could also be utilized as a stand-alone seat assembly, such as for an office seat, theatre seat or any other contemplated use of a seat.

The seat 12 includes a seat back 14 and a seat base 20 that supports a seat cushion 16. The seat back 14 and seat base 20 provide comfort, support and protection to a seated occupant (not shown). The seat 12 may also include a head restraint 18 positioned at an upper end of the seat back 14. The head restraint 18 extends upwardly from the seat back 14 and is configured to provide support and restrain the head of an occupant. The seat back 14 can be pivotably coupled to the seat base 20 via an integrated recliner and motor assembly 130, to be described, such that the seat back 14 can be selectively adjusted with respect to the seat base 20. The seat 12 can also include additional components, such as a side bolsters 26, 28. The seat assembly 12 can also be secured to the vehicle 10 using a track assembly 24. In this example, the track assembly 24 enables the seat assembly to be repositioned relative the vehicle floor to enhance comfort and utility.

The seat back 14 and seat base 20 includes a seat frame 32 and a seat cover 30 overlying the seat frame 32. A padding (not shown) may be disposed between the seat frame and seat cover 30 to provide a desired shape and support to the seat. The seat flame assembly 32 includes a seat back frame 36, and a seat base frame 38. The seat back frame 36 includes an upper cross member 40, a lower cross member 12, a first (inboard) seat back side member 44, and a second (outboard seat back side member 46. The upper cross member 40 is generally planar and includes a first end 48 and an opposed second end 50. The lower cross member 42 is generally planar and. includes a first end. 52 and an opposed second end 54, The first (inboard) seat back side member 44 is generally planar and includes a first upper or top end 56 and a second lower or bottom end 58. The second (outboard) seat back side member 46 is generally planar and includes a first upper or top end 60 and a second lower or bottom end 62. The first upper or top ends of the first and second seat back side members 56, 60 are coupled together by the upper cross member 40 and the second lower or bottom ends of the first and second seat back side members 58, 62 are coupled together by the lower cross member 42 such that a substantially rectangular frame structure 36 is formed.

The seat base frame 38 includes a first (inboard) seat base side member 64, and an opposed second (outboard) seat base side member 66. A front cross member 68 extends between the first seat base side member 64 and second seat base side member 66. Similarly, a rear cross tube member 70 extends between the first seat base side member 64 and second seat base side member 66. The first seat base side member 64 includes a first or front end 72 and a second or rear end 74. The second seat base side member 66 includes a first or front end 76 and a second or rear end 78. The front cross tube member 68 includes a first (inboard) end 80 and a second (outboard) end 82. The rear cross tube member 70 includes a first (inboard) end 84 and a second (outboard) end 86. The front ends of the first and second seat base side member 72, 76 are coupled together by the front cross tube member 68 and the rear ends of the first and second seat base side member 74, 78 are coupled together by the rear cross tube member 70 such that a substantially rectangular frame structure 38 is formed.

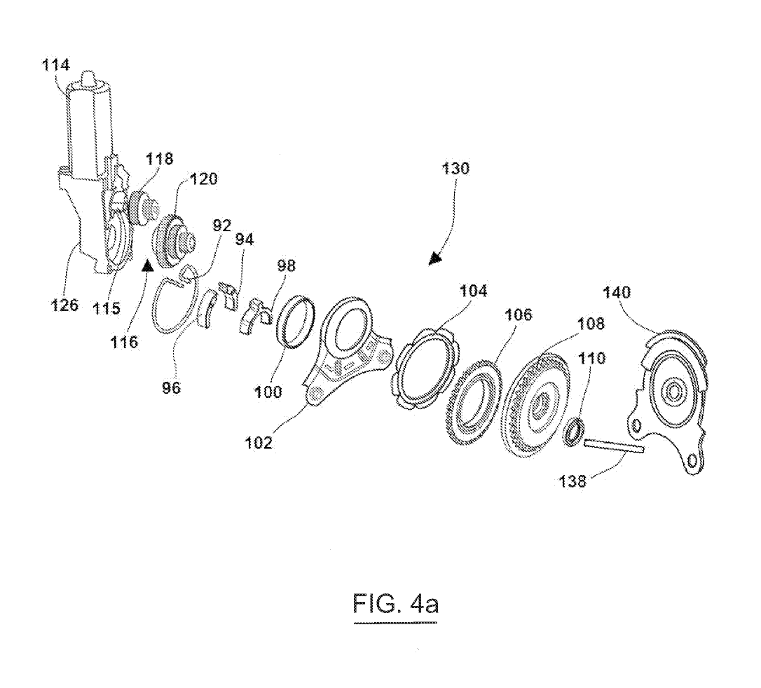

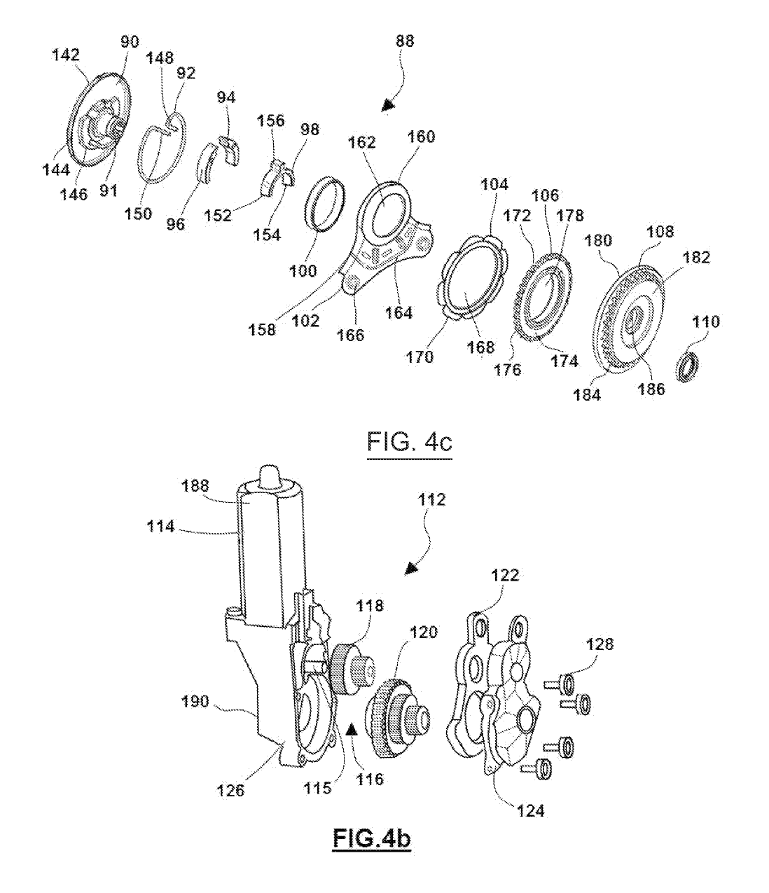

Referring now to FIGS. 4a-4c, an integrated continuous recliner and. motor assembly 130 is illustrated. The integrated continuous recliner and motor assembly provides for variable angular adjustment of the seat back 14 relative to the seat base 20. The angular adjustment positions may be predetermined fixed positions, or continuous positions. The integrated continuous recliner and motor assembly includes a continuous recliner mechanism operatively connected to a motor. The continuous recliner mechanism 88 is coupled to the vehicle seat assembly 12 or a component thereof, such as, the inboard or outboard seat back side members 44, 46 or the like, and operates to selectively adjust the angular orientation of the seat back 14 relative to the seat base 16 or to a compact position relative to the steering wheel, The continuous recliner mechanism 88 is powered by a motor assembly 112.

The continuous recliner mechanism 88 generally includes a driver or drive cap 90, a biasing member 92, a first and second wedge 94, 96, cam member or carrier 98, a ring member or bearing 100, an inner base plate or cushion adapter 102, a ring member or first/inner retainer ring 104, a first or inner gear inner gear 106, a second or outer gear 108, and a driver ring member or second/outer retainer ring 110, as will be described in further detail below.

The driver or drive cap 90 includes a body portion that is a generally planar disc member having a first side 142 and second side 144. The second side includes concentric segments or extensions defining grooves 146 for supporting the first and second wedges 94, 96 in a manner to be described. A shaft 91 extends radially outwardly from the second side 144 of the driver. A biasing member 92 is positioned on the driver cap 90. The biasing member is generally planar and configured to be circular in shape. The biasing member 92 includes a first and second axially extending end 148, 150, The biasing member 92 can be a spring, elastic member, or the like.

The first and second wedges 94, 96 have a generally arcuate shape. The cam member 98 is adjacent the first and second wedges 94,96 and has a generally arcuate or “c” shape. The cam member 98 includes a first end 152 and an opposed second end 154. The cam member 98 also includes an extension portion or tab 156 extending outwardly from its outer surface between its first end 152 and second end 154. The first and second wedges 94, 96 are positioned on either side of the cam member extension 156 respectively. A ring member 100 supports the first and second wedges 94, 96 and cam member 98 on the drive cap 90. The biasing member 92 is operatively interposed between the first and second wedges 94, 96 to bias the wedges 94, 96 into engagement with the cam member 98, the ring member 100, and the driver 90.

The inner base plate 102 is generally planar and includes a body portion 164 having a first side surface 158, a second side surface 160 and a centrally located aperture 162. The body portion 164 includes a plurality of fastener holes 166 for coupling to other structures, such as a seat, or the like. The first side 158 provides a support surface for the driver 90, the biasing spring 92, the wedges 94, 96, the cam member 98, and the ring member 100.

The retainer ring member 104 is annular in shape and includes a central hole 168 and a plurality of extensions or tabs 170 extending outwardly from the outer surface of the ring member 104. The tabs 170 provide for engagement with other components of the mechanism, the seat, or the like. The retainer ring member 104 can also include a plurality of teeth for additional strength and engagement with other components, such as the recliner gears, or the like. The retainer ring member 104 is attached to the second side 160 of the inner base plate 102 and provides a support for the first recliner gear 106. The first recliner gear 106 includes a first side 172, a second side 174. The first recliner gear includes a plurality of radially projecting gear teeth 176 and a central aperture 178. The second recliner gear 108 includes a first side 180 and second side 182 including a plurality of radially extending gear teeth 184 disposed in a circular array and a central hole 186. The drive ring member 110 is secured to the driver 90 to hold the recliner mechanism 88 together.

The motor assembly 112 includes a motor 114, an output or drive shaft 115, a transmission or gear train 116 having a predetermined gear ratio, a first transmission gear 118, a second transmission gear 120, a gear plate 122, a gear or transmission cap 124, a transmission or gear train housing 126, and fasteners 128. The motor 114 includes a housing having a first end 188 and a second end 190, and the transmission or gear train housing 126 is coupled thereto. The output or drive shaft 115 is coupled to the motor 114 and extends laterally a predetermined distance from the housing 126 to engage the first transmission gear 118 of the gear train 116. The first transmission gear 118 includes a first portion 192 and a second portion 194 having a predetermined diameter or size. The first and second portion 192, 194 include a plurality of teeth 195, 197 located on their outside perimeters or surfaces. The second transmission gear 120 includes a first side or surface 196 and a second side or surface 198 and has a predetermined diameter or size that includes a plurality of teeth 200 located on its outside perimeter or surface. The second transmission gear 120 also includes a collar 202 and a shaft 132 that extends outwardly a predetermined distance from the first and second sides, The plurality of teeth 195, 200 on the first and second transmission gears operatively engage one another to rotate a drive shaft that drives the recliner mechanism 88,

The integrated continuous recliner and motor mechanism 130 integrates the components of the continuous recliner mechanism 88 with the motor assembly 112 into a single compact unit. It should be appreciated that certain components, such as, the driver or drive cap 90, the gear plate 122, the gear or transmission cap 124, or the like may be separately assembled. The wedges 94, 96 are positioned on the second gear 120, such as on the extended shaft portion 132, or the like, and/or in direct engagement with the second gear 120, The mechanism further includes a drive shaft 138 having a first end coupled to the mechanism 130, such as the motor 114 or the like, and a second end coupled to a second recliner mechanism 140 positioned on an opposing side of the seat, The integrated continuous recliner and motor mechanism 130 can be used in a dual-sided recliner application, or as a single-sided application.

In operation, a seat occupant activates a control to initiate operation of the motor 112 to adjust the angular orientation of the seat back 14 from an initial position to a final position over a predetermined adjustment rage. An example of a control is a button, or lever or the like. The motor 114 operatively rotates the output shaft 115, which engages the first gear 118 of the gear train or transmission 116 causing the first gear 118 to rotate. The first gear 118, in turn, meshingly engages the second gear 120. As the second gear 120 rotates, the shaft of the second gear 120 rotates the wedges 94, 96 until one of the first and second wedges 94, 96 contacts the tab of the cam member 98. The cam member 98 then rotates, resulting in rotary engagement of the first and second gears 106, 108. The rotational movement of the first and second gears 106, 108 thereby transfers the rotational torque generated by the motor to the drive shaft to create movement of the recliner mechanism 88 and thereby the seat back 14 to provide for continuous adjustment of the seat back over the adjustment range.

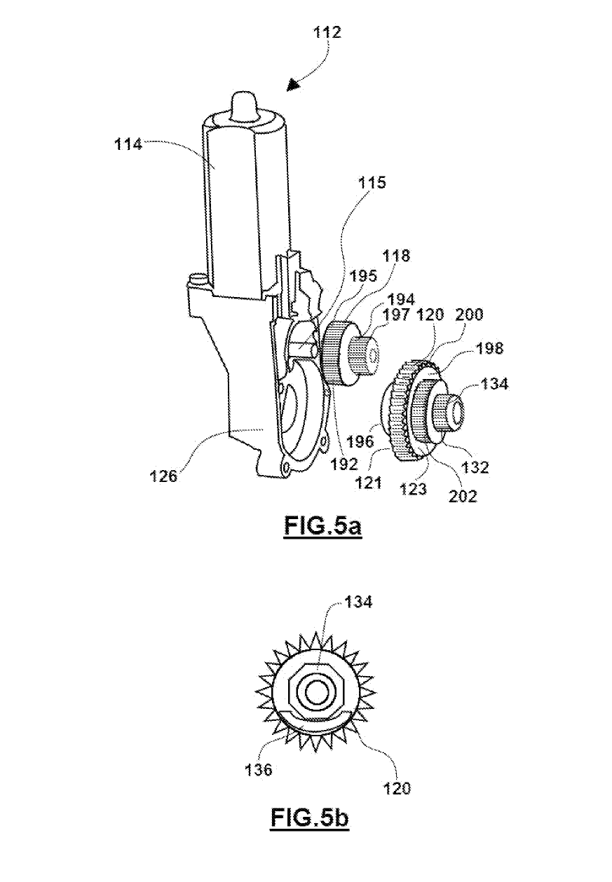

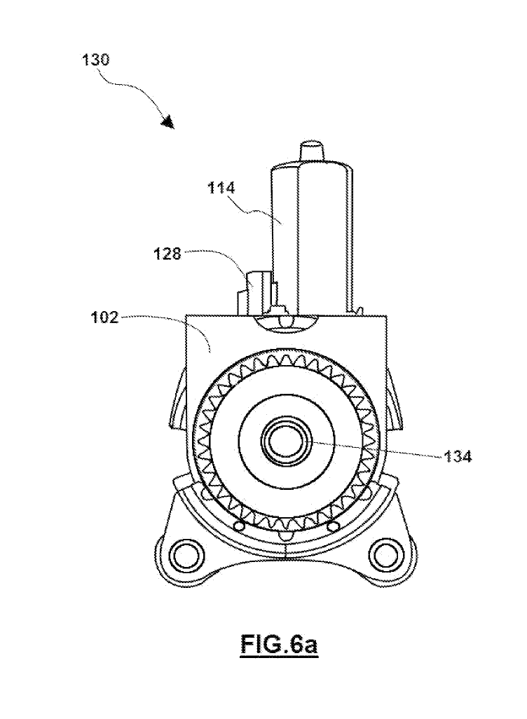

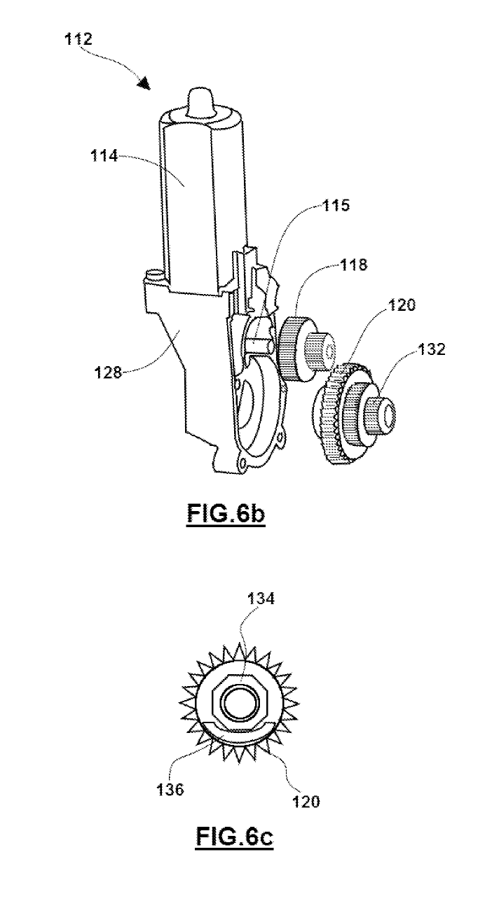

Referring now to FIGS. 5a through 6c, another example of a motor assembly 112 for use with the integrated continuous recliner and motor mechanism 130 is shown. The modified motor assembly 112 includes a second gear 120 having a shaft portion 132 that extends a predetermined length so that it protrudes through the recliner mechanism 88. For example, the shaft portion 132 may extend through the base plate 102, the retainer ring member 104, the recliner first gear 106, the recliner second gear 108, or the like, to provide a locking surface to hold the mechanism together and, to drive the recliner mechanism 88. This structure eliminates the need for the driver or drive cap 90 and creates and even more efficient mechanism and compact design. The extended shaft portion 132 essentially replaces the extrusion/extension 91 on the recliner driver or drive cap 90. The extended shaft portion 132 also enables the gear or transmission cap 124 to be eliminated, from the motor assembly 112. A locking member 134, such as a lock washer, or the like, may be coupled to the shaft 132 to secure the second gear 120, the motor assembly 112, and the recliner mechanism 88 together. The second gear 120 also includes a drive tab 136 coupled thereto and located on the second side of the second gear 120.

In operation, the motor 114 generates power to rotate the output or drive shaft 115. The output or drive shaft engages the first gear 118 of the gear train or transmission 116 causing the first gear 118 to rotate. The first gear 118, in turn, engages the second gear 120, to rotate the second gear 120. As the second gear 120 rotates, the extended, shaft 132 and drive tab 136 drive the wedges 94, 96 thereby transferring the rotational torque generated by the motor to create movement of the recliner mechanism 88 and thereby the seat back 14.

Referring to FIGS. 6a-6c, another example of the integrated continuous recliner and motor assembly 130 is illustrated. In this example, the wedges 94, 96 can be integrated into the gear motor design by integrating the wedges 94, 96 onto the gear motor transmission, such as, the second gear 120, or the like. As a result, the assembly 130 can be more compact and assembly is improved.

Many modifications and variations of the present disclosure are possible in light of the above teachings. Therefore, within the scope of the appended claim, the present disclosure may be practiced other than as specifically described.

What is claimed is:

1. An integrated recliner and motor assembly for adjusting an angular position of a seat back with respect to a seat base comprising:
a recliner mechanism and a gear motor, the gear motor having an output shaft extending therefrom and a transmission;
a first wedge member and a second wedge member disposed about the output a shaft;
a biasing member disposed between the first wedge member and second wedge member to operatively engage the first wedge member or second wedge member with a cam member;
a first recliner gear having a plurality of gear teeth;
a second recliner gear adjacent to the first recliner gear and operatively engaged with the first recliner gear teeth;
wherein the transmission includes a gear train having a drive shaft and a drive tab that directly engages the first wedge and second wedge, wherein the motor generates rotational torque that is transferred from the output shaft to the drive shaft to rotate the first wedge and second wedge until either one of the first wedge or second wedge is in contact with the cam member to initiate rotational movement of the first recliner gear and second recliner gear to adjust the angular position of the seat back with respect to the seat base.

2. The seat adjustment mechanism of claim 1, wherein the recliner disc member includes a shaft extending outwardly from the recliner disc member.

3. The seat adjustment mechanism of claim 1, further comprising a locking member that interlocks the recliner, the gear and the motor together.

4. The seat adjustment mechanism of claim 3, wherein the locking member is a lock washer disposed on the drive shaft of the gear.

5. The seat adjustment mechanism of claim 1, further comprising a recliner drive shaft having a first end operatively engaged to the recliner and a second end operatively engaged to an opposed second recliner secured to an opposite side of the vehicle seat to synchronize the recliner to the second recliner.

6. The seat adjustment mechanism of claim 1, further comprising a bearing ring member that encircles the first wedge member, the second wedge member and the cam member.

7. The seat adjustment mechanism of claim 1, wherein the biasing member is a circular spring member.

8. The seat adjustment mechanism of claim 1, wherein the cam member is arcuate in shape and includes an outwardly extending tab, and the first wedge and second wedge are positioned on either side of the cam member tab.

9. (canceled)

10. (canceled)

11. The seat adjustment mechanism of claim 1, further comprising a drive ring member attached to the shaft to secure the recliner mechanism together.

12. (canceled)

13. The seat adjustment mechanism of claim 1, wherein the transmission, the motor, the gear train and at least a portion of the recliner mechanism are at least partially disposed within a transmission housing.

14. (canceled)

15. (canceled)
